(19) United States
(12) Patent Application Publication
(10) Pub. No.: US 2019/0015830 A1
(43) Pub. Date: Jan. 17, 2019

(54) CAP AND FLUID HANDLING TUBE COMPONENTS AND ASSEMBLIES

(71) Applicant: BIOTIX, Inc., San Diego, CA (US)

(72) Inventors: Peter Paul BLASZCAK, San Diego, CA (US); Arta MOTADEL, San Diego, CA (US)

(21) Appl. No.: 16/069,435

(22) PCT Filed: Jan. 9, 2017
(86) PCT No.: PCT/US17/12743

§ 371 Date: Jul. 11, 2018

Related U.S. Application Data
(60) Provisional application No. 62/279,497, filed on Jan. 15, 2016.

(51) Int. Cl. B01L 3/00

(52) U.S. Cl. CPC B01L 3/50825; B01L 2200/087; B01L 2200/0689; B01L 2300/0832; B01L 2300/042

(57) ABSTRACT

Provided herein are cap and tube component embodiments that permit ergonomic engagement and disengagement. Also provided herein are assemblies thereof in which a cap is in sealing engagement with a tube. When engaged with a tube, a cap may be pivoted with respect to a point located on the interior rim of the tube opening by applying a relatively small force to the exterior surface of the cap. Pivoting the cap at this point on the tube can break the seal between the tube and cap and permit removal of the cap from the tube for manipulation of fluid in the tube.

### RELATED PATENT APPLICATIONS

This patent application is a 35 U.S.C. 371 national phase patent application of PCT/US2017/012743, filed on Jan. 9, 2017, entitled CAP AND FLUID HANDLING TUBE COMPONENTS AND ASSEMBLIES, naming Peter Paul Blaszcak and Arta Motadel as inventors, and designated by Attorney Docket No. PEL-1022-PC which claims the benefit of U.S. provisional application No. 62/279,497, filed Jan. 15, 2016, entitled CAP AND FLUID HANDLING TUBE COMPONENTS AND ASSEMBLIES, naming Peter Paul Blaszcak and Arta Motadel as inventors, and designated by Attorney Docket No. PEL-1022-PV. The entirety of the foregoing patent applications, including all text, tables and drawings, are incorporated herein by reference for all purposes.

### FIELD

The technology relates in part to cap and tube components that can be engaged and disengaged ergonomically. The technology also relates in part to assemblies thereof in which a cap is in sealing engagement with a tube.

### BACKGROUND

A test tube often is used to store and handle fluids in laboratory settings and sometimes is provided with a cap that can be engaged with the tube to protect fluid in the tube from spillage, evaporation and/or contamination, for example. A cap can be in sealing engagement with a tube counterpart, and a portion of such a cap can be inserted within the tube interior to facilitate an air-tight seal.

### SUMMARY

Provided in certain aspects is a cap configured to engage with a fluid handling tube, which cap includes: a proximal terminal surface, a distal opening and an interior void. The cap typically also includes a tube insert region disposed proximal to the distal opening. A tube insert region of cap often includes two or more annular projections disposed on the tube insert region, and a circumference around an exterior surface of the tube insert region disposed proximal to the annular projections. Generally, the cap also includes axially oriented ribs disposed around the circumference. Ribs often are disposed proximal to the tube insert region, and often are disposed distal to the proximal terminal surface. The tube insert region typically includes an axial length and a minimum outer diameter between the annular projections, where a ratio of the axial length to the diameter often is less than 0.62.

Also provided in certain aspects is an assembly that includes a cap described above and a tube configured to engage the cap. A tube and the cap often are configured for sealing engagement.

Provided also in certain aspects are methods for using caps and tubes described herein. Certain methods pertain to engaging a cap with a tube, and some methods pertain to disengaging a cap from a tube. Also provided in certain aspects are methods for manufacturing caps and tubes described herein, and molds used in manufacturing processes.

Certain embodiments are described further in the following description, examples, claim(s) and drawings.

### BRIEF DESCRIPTION OF THE DRAWINGS

The drawings illustrate certain embodiments of the technology and are not limiting. For clarity and ease of illustration, the drawings are not necessarily made to scale and, in some instances, various aspects may be shown exaggerated or enlarged to facilitate an understanding of particular embodiments.

FIG. 1 shows a top view of a fluid handling tube embodiment. FIG. 2A shows a front side view thereof, FIG. 2B shows a right side view thereof and FIG. 2C shows a left side view thereof. The back side view thereof is the same as the front side view shown in FIG. 2A. FIG. 3 shows a bottom view thereof. FIG. 4 shows a cross sectional view thereof through section A-A shown in FIG. 1, and FIG. 5 is an enlarged view of the region encircled in FIG. 4. FIG. 6 shows a top perspective view thereof and FIG. 7 shows a bottom perspective view thereof.

FIG. 8 shows a top view of a fluid handling tube embodiment that includes volume graduations. FIG. 9A shows a front side view thereof, FIG. 9B shows a right side view thereof and FIG. 9C shows a left side view thereof. The back side view is the same as the left side view shown in FIG. 9C. FIG. 10 shows a bottom view thereof. FIG. 11 shows a cross sectional view thereof through section C-C shown in FIG. 8, and FIG. 12 is an enlarged view of the region encircled in FIG. 11. FIG. 13 shows a top perspective view thereof and FIG. 14 shows a bottom perspective view thereof.

FIG. 15 shows a top view of a cap embodiment configured for sealing connection with a fluid handling tube embodiment shown in FIG. 1 to FIG. 14. FIG. 16 shows a side view thereof, FIG. 17 shows a cross sectional view thereof through section E-E shown in FIG. 16, and FIG. 17A shows an enlarged view of the region encircled in FIG. 17. FIG. 18 shows a bottom view thereof, FIG. 19 shows a top perspective view thereof, and FIG. 20 shows a bottom perspective view thereof.

FIG. 21 shows a top view of a fluid handling tube and cap assembly embodiment. FIG. 22 shows a side view thereof and FIG. 23 shows a cross sectional view thereof through section F-F shown in FIG. 21. FIG. 24 shows a side view a fluid handling tube and cap assembly embodiment in which the cap is in a pivoted orientation with respect to the tube.

FIG. 25 to FIG. 48 show fluid handling tube embodiments, and corresponding cap and assembly embodiments, for which the tube is configured to retain a larger fluid volume than the tube embodiments shown in FIG. 1 to FIG. 14.

FIG. 25 shows a top view of a fluid handling tube embodiment. FIG. 26A shows a front side view thereof, FIG. 26B shows a right side view thereof and FIG. 26C shows a left side view thereof. The back side view thereof is the same as the front side view shown in FIG. 26A. FIG. 27 shows a bottom view thereof. FIG. 28 shows a cross sectional view thereof through section G-G shown in FIG. 25, and FIG. 29 is an enlarged view of the region encircled in FIG. 28. FIG. 30 shows a top perspective view thereof and FIG. 31 shows a bottom perspective view thereof.

FIG. 32 shows a top view of a fluid handling tube embodiment that includes volume graduations. FIG. 33A shows a front side view thereof, FIG. 33B shows a right side view thereof and FIG. 33C shows a left side view thereof. The back side view is the same as the left side view shown in FIG. 33C. FIG. 34 shows a bottom view thereof. FIG. 35 shows a cross sectional view thereof through section I-I shown in FIG. 32, and FIG. 36 is an enlarged view of the region encircled in FIG. 35.

FIG. 37 shows a top perspective view thereof and FIG. 38 shows a bottom perspective view thereof.

FIG. 39 shows a top view of a cap embodiment configured for sealing connection with a fluid handling tube embodiment shown in FIG. 25 to FIG. 38. FIG. 40 shows a side view thereof, FIG. 41 shows cross sectional view thereof through section K-K shown in FIG. 40, and FIG. 41A shows an enlarged view of the region encircled in FIG. 41. FIG. 42 shows a bottom view thereof, FIG. 43 shows a top perspective view thereof, and FIG. 44 shows a bottom perspective view thereof.

FIG. 45 shows a top view of a fluid handling tube and cap assembly embodiment. FIG. 46 shows a side view thereof and FIG. 47 shows a cross sectional view thereof through section L-L shown in FIG. 45. FIG. 48 shows a side view a fluid handling tube and cap assembly embodiment in which the cap is in a pivoted orientation with respect to the tube.

Certain features in the drawings are summarized in Table 1.

TABLE 1

| Callout | Element |
|---|---|
| 100 | Fluid handling tube embodiment |
| 105 | Tube flange proximal surface |
| 107 | Tube flange distal surface |
| 110 | Tube flange edge |
| 115 | Tube interior |
| 120 | Tube interior bottom; gate dimple interior surface |
| 122 | Tube exterior bottom; gate dimple exterior surface |
| 125 | Tube exterior sidewall |
| 130 | Cap insertion region |
| 135 | Tube exterior side-to-bottom transition |
| 137 | Tube interior sidewall |
| 140 | Tube first interior annular projection |
| 145 | Tube second interior annular projection |
| 200 | Fluid handling tube embodiment (includes volume graduations) |
| 205 | Tube flange proximal surface |
| 207 | Tube flange distal surface |
| 210 | Tube flange edge |
| 215 | Tube interior |
| 220 | Tube interior bottom |
| 222 | Tube exterior bottom |
| 225 | Tube exterior sidewall |
| 230 | Cap insertion region |
| 235 | Tube exterior side-to-bottom transition |
| 237 | Tube interior sidewall |
| 240 | Tube first interior annular projection |
| 245 | Tube second interior annular projection |
| 250A | Tube line graduation |
| 250B | |
| 250C | |
| 250D | |
| 255A | Tube volume designation for corresponding line graduation |
| 255B | |
| 255C | |
| 255D | |
| 300 | Cap embodiment |
| 305 | Cap proximal terminus surface |
| 310 | Cap proximal terminus surface center; gate dimple |
| 315 | Cap proximal sidewall |
| 320 | Cap proximal terminus-to-sidewall transition |
| 325A | Cap rib, axially oriented |
| 325B | |
| 327 | Cap rib distal terminus |
| 330 | Tube insert region |
| 332 | Tube insert region axial length |
| 334 | First insert region projection, proximal surface |
| 335 | First insert region projection, apex |
| 339 | Second insert region projection, proximal surface |
| 340 | Second insert region projection, apex |
| 345 | Tube insert region sidewall |
| 350 | Cap distal terminus |
| 355 | Cap interior |
| 360 | Cap interior sidewall |
| 370 | Cap distal terminus edge |
| 400 | assembly embodiment that includes fluid handling tube and cap |
| 410 | Tube interior diameter |
| 450 | Assembly embodiment in which cap is pivoted with respect to |
| | tube interior sidewall |
| 460 | Cap exterior surface and tube interior surface pivot point |
| 500 | Fluid handling tube embodiment |
| 505 | Tube flange proximal surface |
| 507 | Tube flange distal surface |
| 510 | Tube flange edge |
| 515 | Tube interior |
| 520 | Tube interior bottom |
| 522 | Tube exterior bottom |
| 525 | Tube exterior sidewall |
| 530 | Cap insertion region |
| 535 | Tube exterior side-to-bottom transition |
| 537 | Tube interior sidewall |
| 540 | Tube first interior annular projection |
| 545 | Tube second interior annular projection |
| 600 | Fluid handling tube embodiment (includes volume graduations) |
| 605 | Tube flange proximal surface |
| 607 | Tube flange distal surface |
| 610 | Tube flange edge |
| 615 | Tube interior |
| 620 | Tube interior bottom |
| 622 | Tube exterior bottom |
| 625 | Tube exterior sidewall |
| 630 | Cap insertion region |
| 635 | Tube exterior side-to-bottom transition |
| 637 | Tube interior sidewall |
| 640 | Tube first interior annular projection |
| 645 | Tube second interior annular projection |
| 650 | Tube line graduation |
| 655 | Tube volume designation for corresponding line graduation |
| 700 | Cap embodiment |
| 705 | Cap proximal terminus surface |
| 710 | Cap proximal terminus surface center; gate dimple |
| 715 | Cap proximal sidewall |
| 720 | Cap proximal terminus-to-sidewall transition |
| 725A | Cap rib, axially oriented |
| 725B | |
| 727 | Cap rib distal terminus |
| 730 | Tube insert region |
| 732 | Tube insert region axial length |
| 734 | First insert region projection, proximal surface |
| 735 | First insert region projection, apex |
| 739 | Second insert region projection, proximal surface |
| 740 | Second insert region projection, apex |
| 745 | Tube insert region sidewall |
| 750 | Cap distal terminus |
| 755 | Cap interior |
| 760 | Cap interior sidewall |
| 770 | Cap distal terminus edge |
| 800 | assembly embodiment that includes fluid handling tube and cap |
| 810 | Tube interior diameter |
| 850 | Assembly embodiment in which cap is pivoted with respect to |
| | tube interior sidewall |
| 860 | Cap exterior surface and tube interior surface pivot point |

### DETAILED DESCRIPTION

Provided in part herein are cap and tube component embodiments that permit ergonomic engagement and disengagement. Also provided in part herein are assemblies thereof in which the cap is in sealing engagement with the tube. A tube insert region of the cap and a corresponding cap insertion region of the tube often are configured to permit sealing engagement of the tube and the cap, where the tube and cap can remain sealed at an external/internal pressure differential of about 6 kilopascals (see further description hereafter). The tube insertion region of the cap often is configured for enhanced ergonomic use by an operator. Enhanced ergonomics are facilitated in part by (i) requirement of a relatively minimal force to engage or disengage the cap and tube, and (ii) pivoting movement of the cap and tube for engagement and disengagement. When engaged with a tube, the tube insert region of a cap often is configured to permit pivoting movement of the cap with respect to a point located on the interior rim of the tube opening. Pivoting the cap at this point on the tube can break the seal between the tube and cap and permit removal of the cap from the tube for manipulation of fluid the tube (e.g., introducing fluid to the tube, removing fluid from the tube, manipulating fluid in the tube). A cap may be pivoted at a pivot point by applying a relatively small force to the exterior surface of the cap.

### Caps

Provided in certain embodiments are caps that can be sealingly engaged with tubes and used in an ergonomic manner by an operator. Provided in some embodiments are caps configured to engage with a fluid handling tube, where the caps include a proximal terminal surface, a distal opening, an interior void, and a tube insert region disposed proximal to the distal opening. A tube insert region often includes two or more annular projections disposed on the tube insert region, and a circumference around an exterior surface of the tube insert region disposed proximal to the annular projections. Caps often include axially oriented ribs disposed around the circumference, disposed proximal to the tube insert region, and disposed distal to the proximal terminal surface. A cap sometimes includes a proximal terminal surface and sometimes includes a sidewall disposed proximal to the ribs and distal to the proximal terminal surface.

A tube insert region often includes an axial length and a minimum outer diameter between the annular projections. In some embodiments, an axial length of the tube insert region sometimes is about 1.5 inches to about 2.5 inches, sometimes is about 0.17 inches to about 0.22 inches, sometimes is about 0.18 inches to about 0.21 inches, sometimes is about 0.19 inches to about 0.20 inches and sometimes is about 0.195 inches. A minimum outer diameter between the annular projections, in certain embodiments, sometimes is about 0.32 inches to about 0.45 inches, sometimes is about 0.387 inches, sometimes is about 0.45 inches to about 0.58 inches, and sometimes is about 0.516 inches.

A ratio of the axial length to the diameter often is less than 0.62. In certain embodiments, the ratio is less than about 0.61, is less than about 0.60, is less than about 0.59, is less than about 0.58, is less than about 0.57, is less than about 0.56, is less than about 0.55, is less than about 0.54, is less than about 0.53, is less than about 0.52, is less than about 0.51, is less than about 0.50, is less than about 0.49, is less than about 0.48, is less than about 0.47, is less than about 0.46, is less than about 0.45, is less than about 0.44, is less than about 0.43, is less than about 0.42, is less than about 0.41, is less than about 0.40, is less than about 0.39, is less than about 0.38, is about 0.2 to about 0.62, is about 0.2 to about 0.61, is about 0.2 to about 0.60, is about 0.21 to about 0.59, is about 0.22 to about 0.58, is about 0.23 to about 0.57, is about 0.24 to about 0.56, is about 0.25 to about 0.55, is about 0.26 to about 0.54, is about 0.27 to about 0.53, is about 0.28 to about 0.52, is about 0.29 to about 0.51, is about 0.30 to about 0.50, is about 0.30 to about 0.55, is about 0.30 to about 0.55, is about 0.31 to about 0.55, is about 0.32 to about 0.55, is about 0.33 to about 0.55, is about 0.34 to about 0.55, or is about 0.35 to about 0.55.

In certain embodiments, annular projections of the cap sometimes extend about 0.001 inches to about 0.01 inches from the exterior surface of the tube insert region disposed proximal to the annular projections (e.g., sidewall 345 shown in FIG. 16), sometimes extend about 0.002 inches to about 0.006 inches from the exterior surface of the tube insert region disposed proximal to the annular projections, sometimes extend about 0.004 inches from the exterior surface of the tube insert region disposed proximal to the annular projections, sometimes extend about 0.005 inches to about 0.009 inches from the exterior surface of the tube insert region disposed proximal to the annular projections, and sometimes extend about 0.007 inches from the exterior surface of the tube insert region disposed proximal to the annular projections.

A cap sometimes includes a polymer, and sometimes is manufactured from a polymer or polymer mixture. A polymer mixture generally includes a polymer and (i) another polymer and/or (ii) a non-polymer component (e.g., softening agent, coloring component and the like). In certain embodiments, a polymer mixture includes one, two or three or more polymers. Non-limiting examples of polymers include polypropylene, polyethylene, high-density polyethylene, low-density polyethylene, polyethylene teraphthalate, polyvinyl chloride, polytetrafluoroethylene, polystyrene, high-density, acrylnitrile butadiene styrene, crosslinked polysiloxane, polyurethane, (meth)acrylate-based polymer, cellulose, cellulose derivative, polycarbonate, and tetrafluoroethylene polymers.

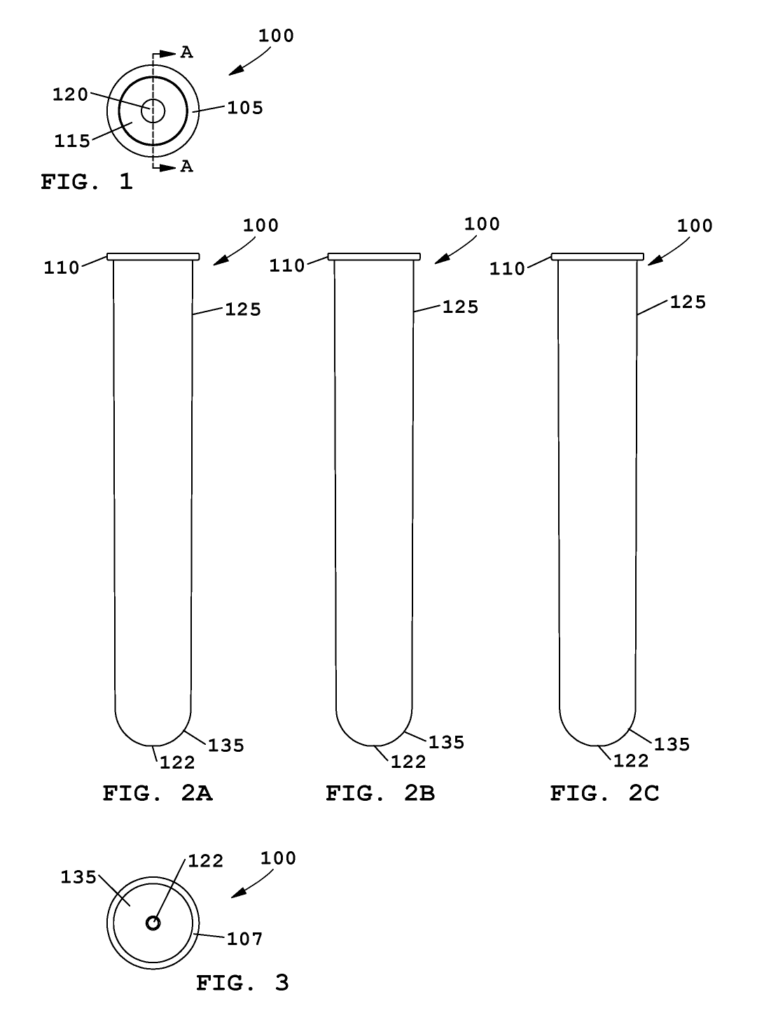

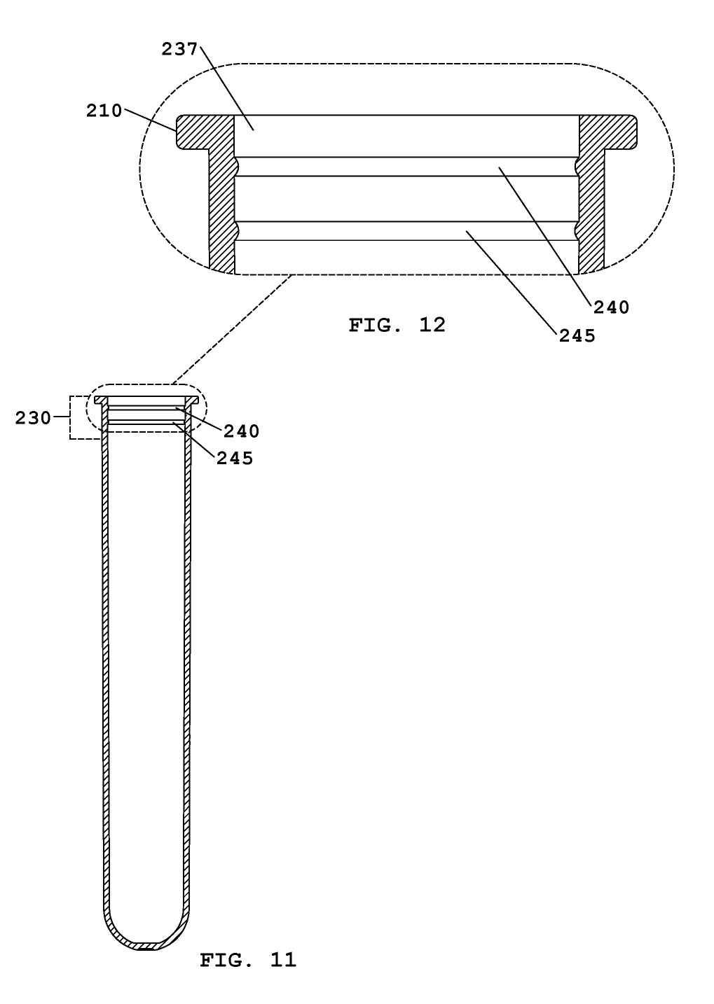

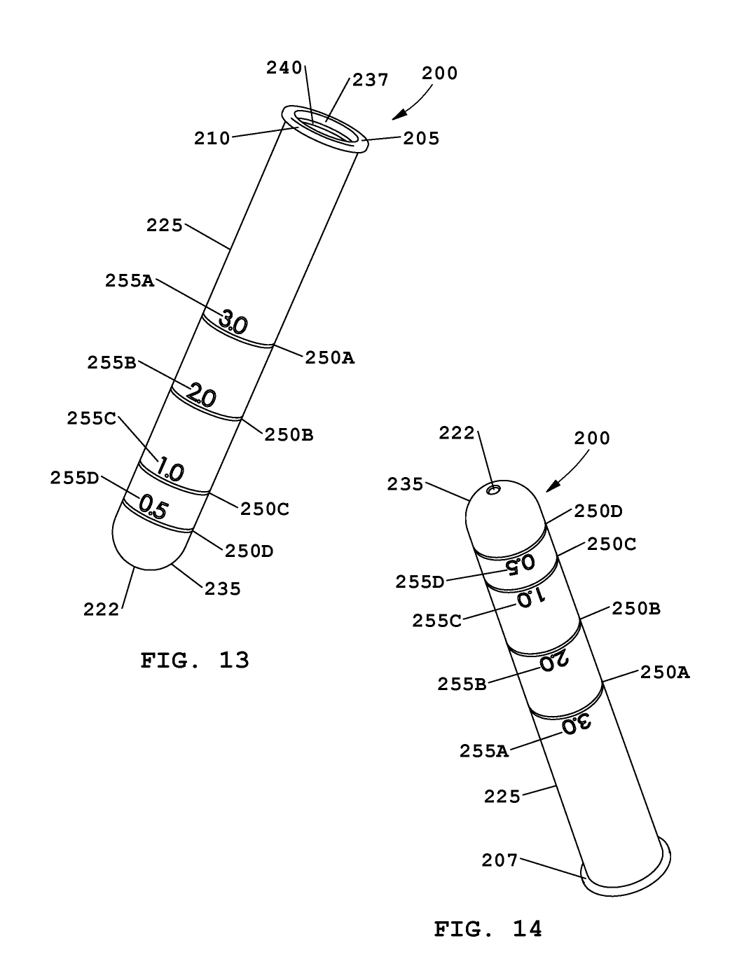

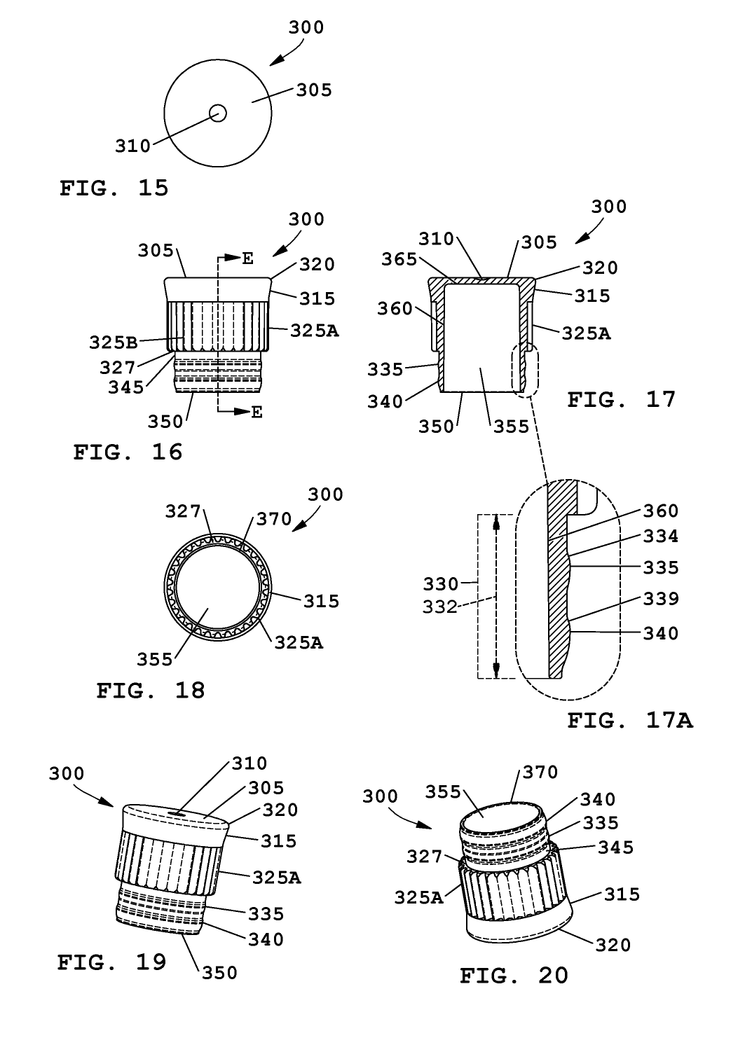

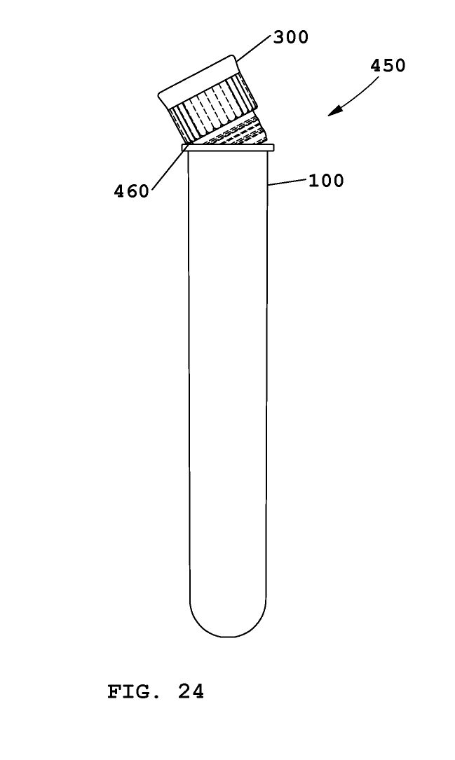

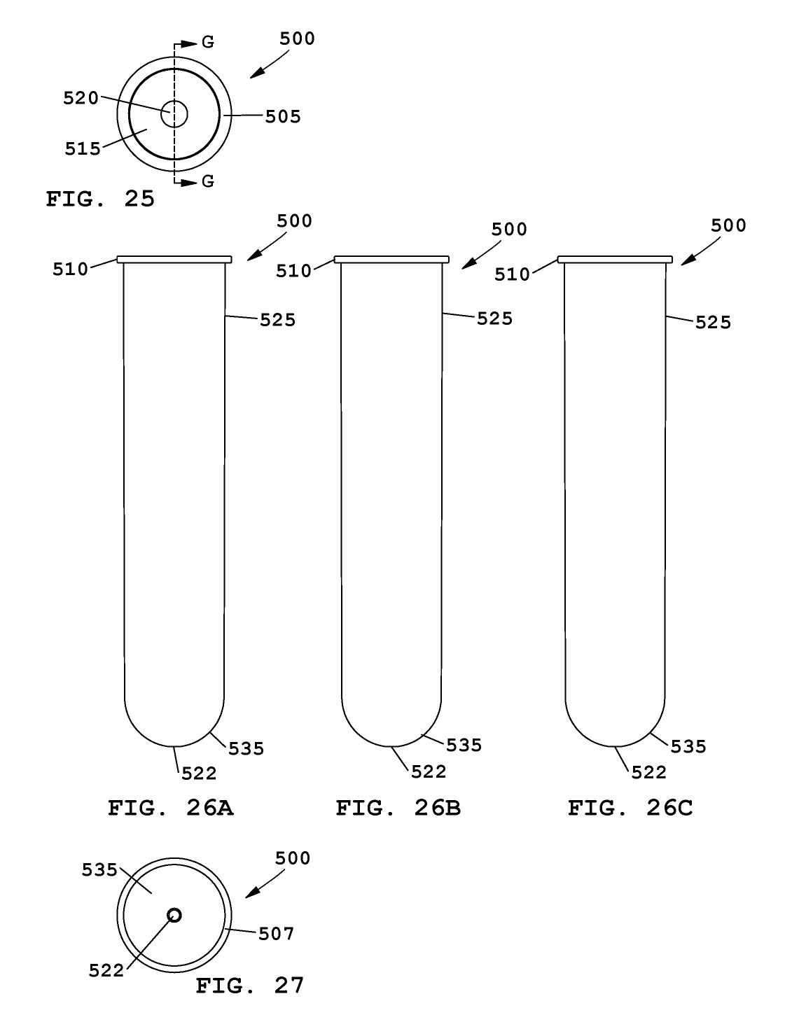

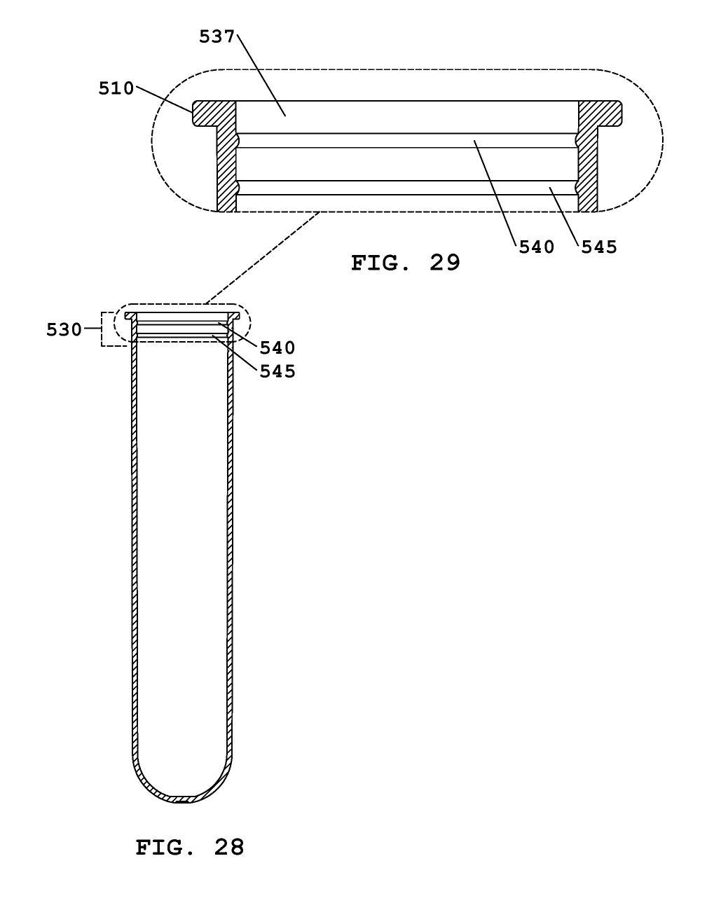

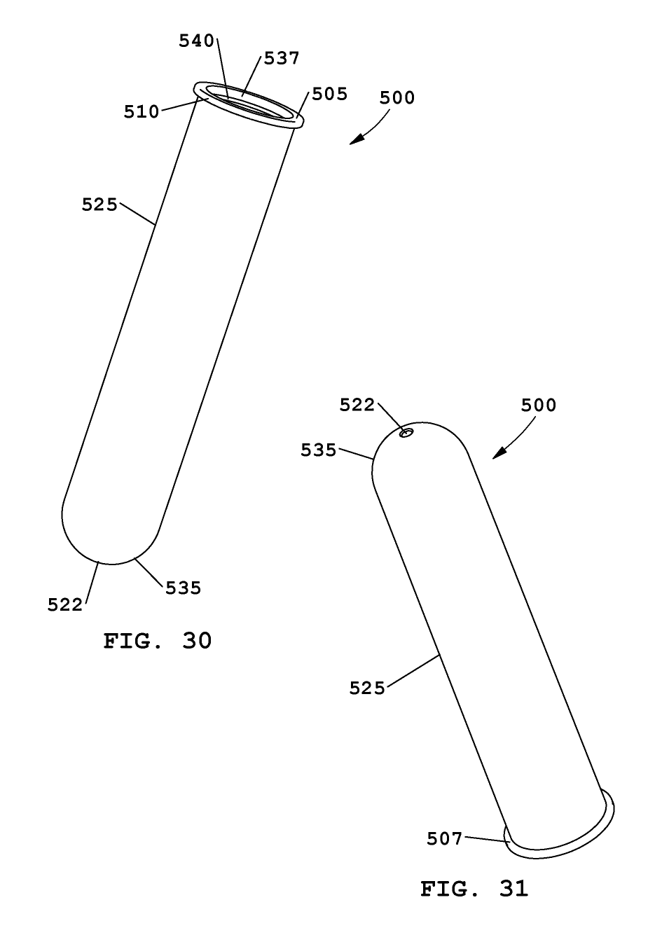

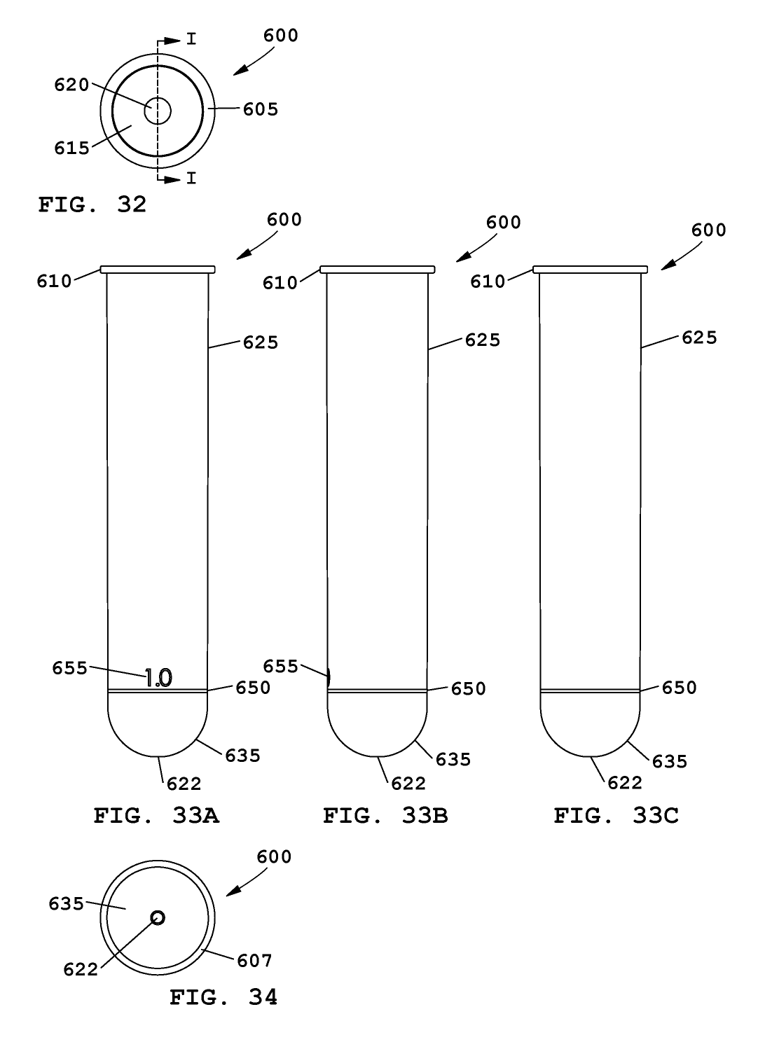

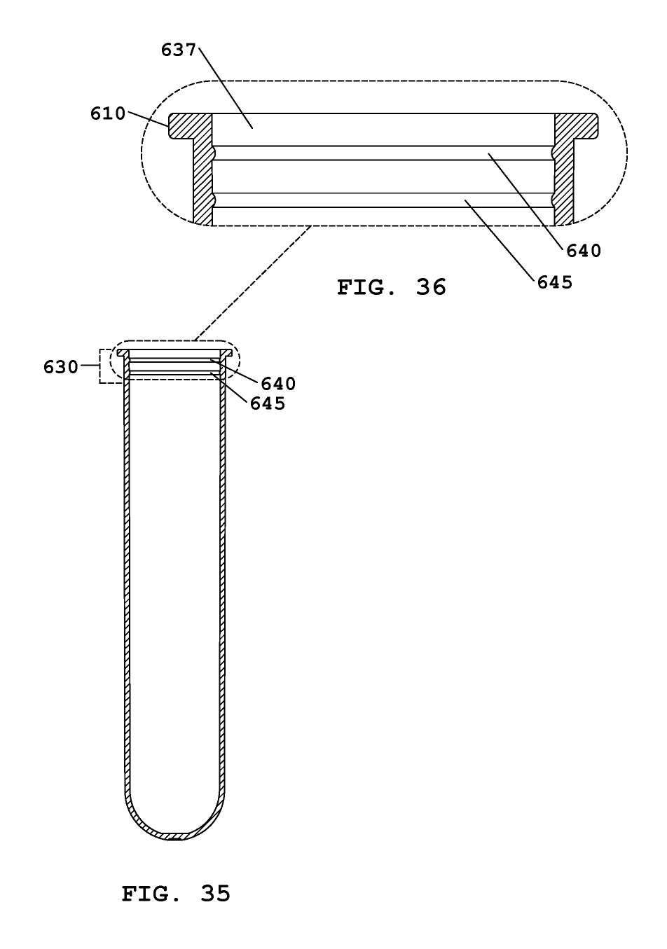

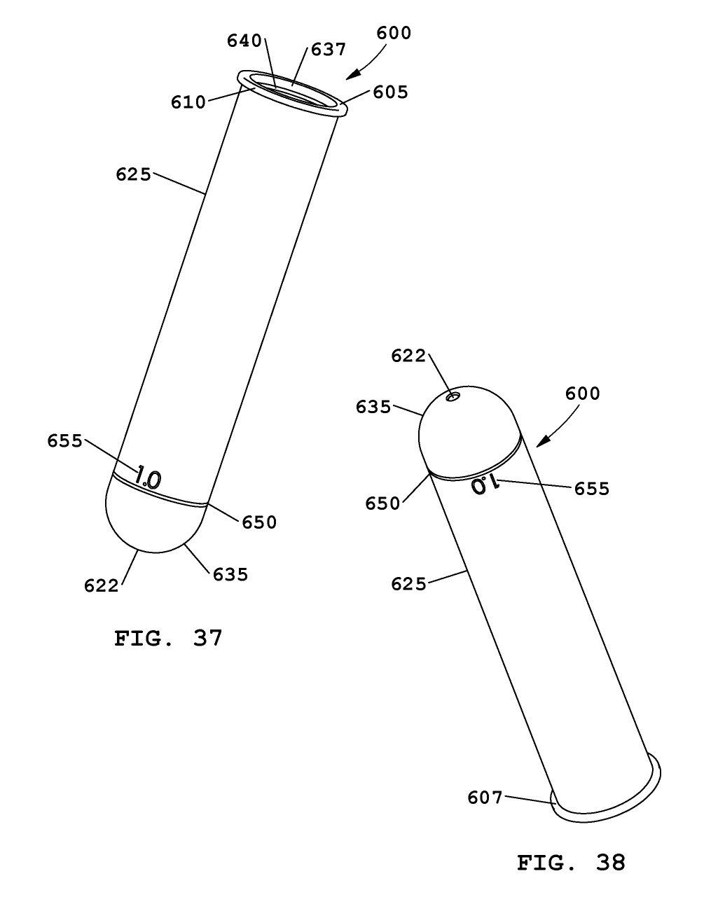

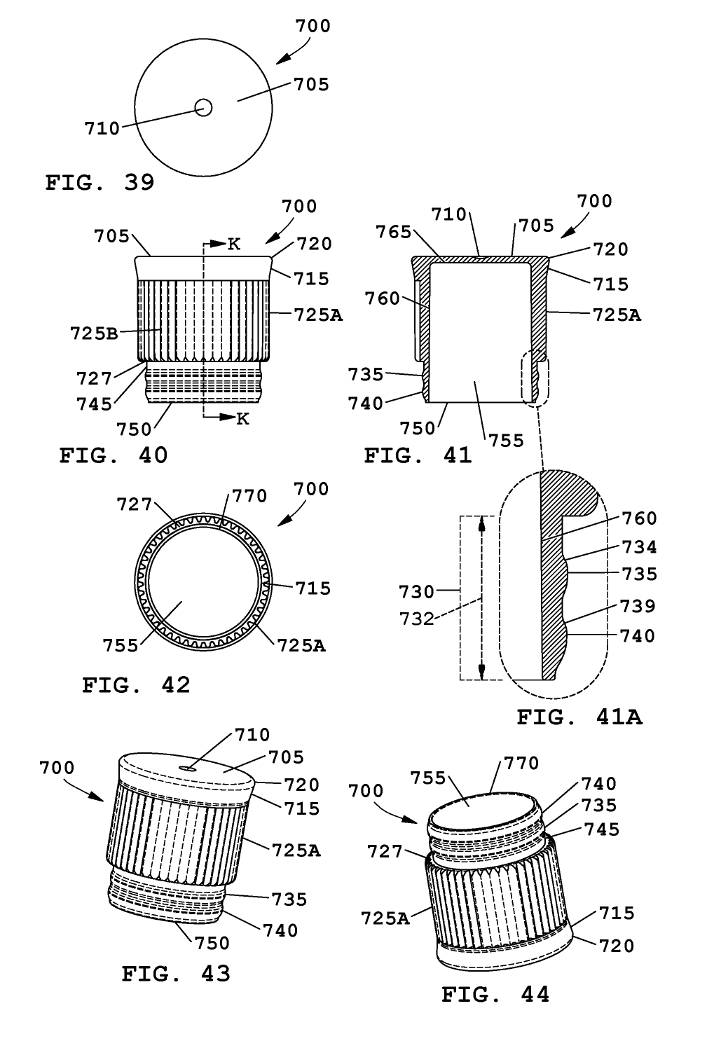

Non-limiting cap embodiments are illustrated in FIG. 15 to FIG. 20 and in FIG. 39 to FIG. 44. Cap embodiments illustrated in FIG. 15 to FIG. 20 are configured to engage fluid handling tubes illustrated in FIG. 1 to FIG. 14. Cap embodiments illustrated in FIG. 39 to FIG. 44 are configured to engage fluid handling tubes illustrated in FIG. 25 to FIG. 38. As addressed herein, fluid handling tubes illustrated in FIG. 25 to FIG. 38 are configured to retain a larger fluid volume than fluid handling tubes illustrated in FIG. 1 to FIG. 14.

FIG. 15 to FIG. 20 illustrate cap embodiment 300 configured for sealing engagement with a fluid handling tube 100 or 200 shown in FIG. 1 to FIG. 14. As illustrated in FIG. 16, the proximal terminus of the cap (e.g., at 305) is at the top of the figure and the distal terminus of the cap (e.g., at 350) is at the bottom of the figure. Cap 300 includes a proximal terminus surface 305 and a gate dimple at the proximal terminus surface center 310. Cap 300 also includes proximal sidewall 315 and a proximal terminus-to-sidewall transition 320. Also included are axially oriented ribs (e.g., 325A, 325B) disposed around the circumference defined by sidewall 345. The ribs generally are distributed on the circumference and are continuously disposed around the cap, with sides of each rib connected to sides of adjacent ribs. In certain embodiments, axially oriented ribs are disposed on the circumference but are arranged with a space between one or more or all of the ribs (i.e., the ribs are not continuously disposed around the cap). The axial orientation of the ribs is a vertical orientation shown in FIG. 16 and in the same direction as the axial length 332 shown in FIG. 17A (i.e., parallel to the axial length 332). The ribs include distal terminus 327 and the rib distal termini define a step between the ribs and sidewall 345.

Cap 300 includes tube insert region 330 having axial length 332. Virtual tangent lines that define surface contours in the tube insert region are shown as broken lines in FIG. 16, FIG. 18, FIG. 19 and FIG. 20. The tube insert region in cap 300 includes first insert region annular projection having an apex 335 and a proximal surface 334 and a second insert region annular projection having an apex 340 and a proximal surface 339. The apexes are the furthest distance the first and second annular projections project from the insert region sidewall (e.g., sidewall 345 in FIG. 16). Cap 300 also includes distal terminus 350, interior 355, interior sidewall 360, and distal terminus edge 370. Cap 300 can be manufactured from a polymer or polymer mixture (e.g., a polymer mixture that includes polypropylene), sometimes has a wall thickness of about 0.010 inches to about 0.035 inches (e.g., about 0.022 or about 0.023 inches) in the tube insert region (not including annular projections) and sometimes weighs about 0.35 grams to about 0.600 grams (e.g., about 0.40 grams to about 0.58 grams, about 0.45 grams to about 0.55 grams, about 0.47 grams to about 0.51 grams, about 0.49 grams or about 0.5 grams).

Cap element counterparts are provided in Table 1 for cap embodiment 700, illustrated in FIG. 39 to FIG. 44, which is configured to engage tube embodiments 500 and 600 shown in FIG. 25 to FIG. 38. Cap 700 can be manufactured from a polymer or polymer mixture (e.g., a polymer mixture that includes polypropylene), sometimes has a wall thickness of about 0.010 inches to about 0.035 inches (e.g., about 0.024 or about 0.025 inches) in the tube insert region (not including annular projections) and sometimes weighs about 0.6 grams to about 1.42 grams (e.g., about 0.7 grams to about 1.3 grams, about 0.8 grams to about 1.2 grams, about 0.9 grams to about 1.1 grams, about 1 gram).

### Tubes

Provided in some embodiments are tubes configured for engagement with caps described above. Any suitable tube that can be joined with a cap and used for fluid handling in a laboratory setting may be utilized, including but not limited to test tubes, culture tubes, centrifuge tubes, general purpose tubes, analyzer tubes, cuvette tubes, pathology tubes, urine collection tubes, histology tubes, operating room tubes and the like. In certain embodiments, a tube includes a proximal opening, a sidewall, an interior, a cap insertion region in the interior and distal to the opening, and a bottom. A tube bottom sometimes is a rounded bottom tube. A tube in certain embodiments includes a flange around the proximal opening, and sometimes a tube includes one or more tube annular projections in the cap insertion region.

In some embodiments, a cap insertion region of a tube includes an inside diameter of about 0.32 inches to about 0.45 inches disposed proximal to the tube annular projections. In certain embodiments, the inside diameter sometimes is about 0.41 inches, sometimes is about 0.45 inches to about 0.58 inches, and sometimes is about 0.54 inches.

A tube sometimes includes a polymer, and sometimes is manufactured from a polymer or polymer mixture. Non-limiting examples of polymer mixtures and polymers include those described above with respect to caps.

Non-limiting tube embodiments are illustrated in FIG. 1 to FIG. 14 and in FIG. 25 to FIG. 38. Tube embodiments illustrated in FIG. 25 to FIG. 38 are configured to retain a larger fluid volume than tube embodiments illustrated in FIG. 1 to FIG. 14. FIG. 1 to FIG. 14 illustrate tube embodiment 100 and tube embodiment 200. As illustrated in FIG. 2A and FIG. 9A, the proximal terminus of each tube is at the top of the figure and the distal terminus of each tube is at the bottom of the figure.

Tube 100 includes flange proximal surface 105, flange distal surface 107 and flange edge 110. Tube 100 also includes tube interior 115, interior bottom 120, exterior bottom 122, exterior sidewall 125 and an exterior side-to-bottom transition 135. Exterior bottom 122 includes a gate dimple exterior surface, and interior bottom 120 includes a gate dimple interior surface. Tube 100 also includes a cap insertion region 130, shown in FIG. 4, configured to receive the tube insert region 330 of cap 300. Tube 100 also includes interior sidewall 137, a first interior annular projection 140 and a second interior annular projection 145, as shown in FIG. 4 and FIG. 5.

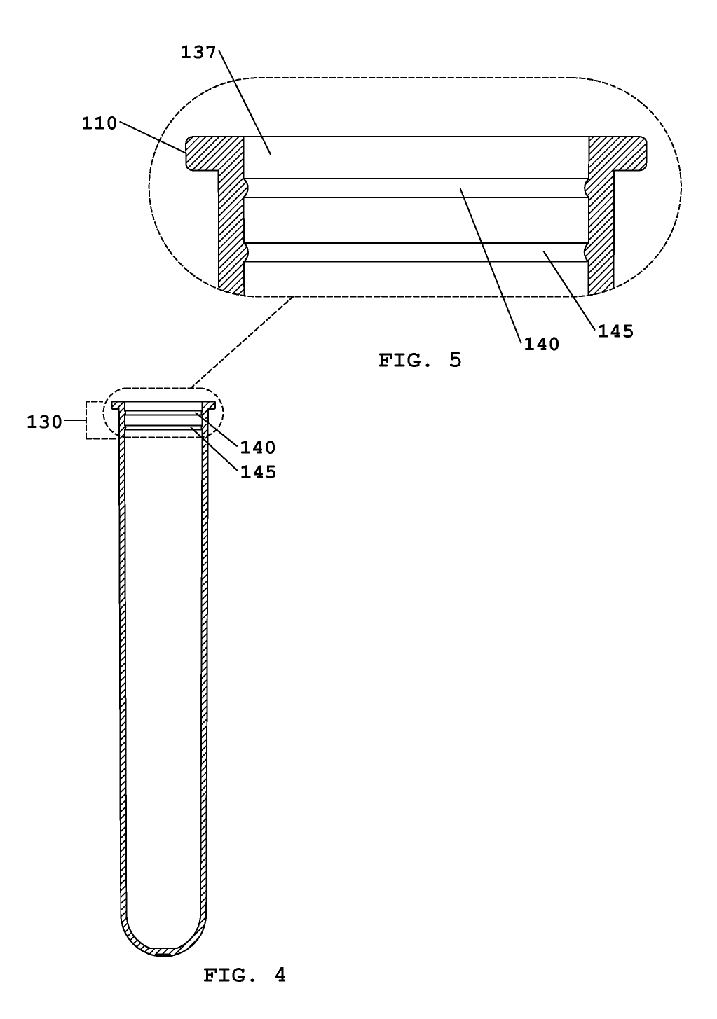

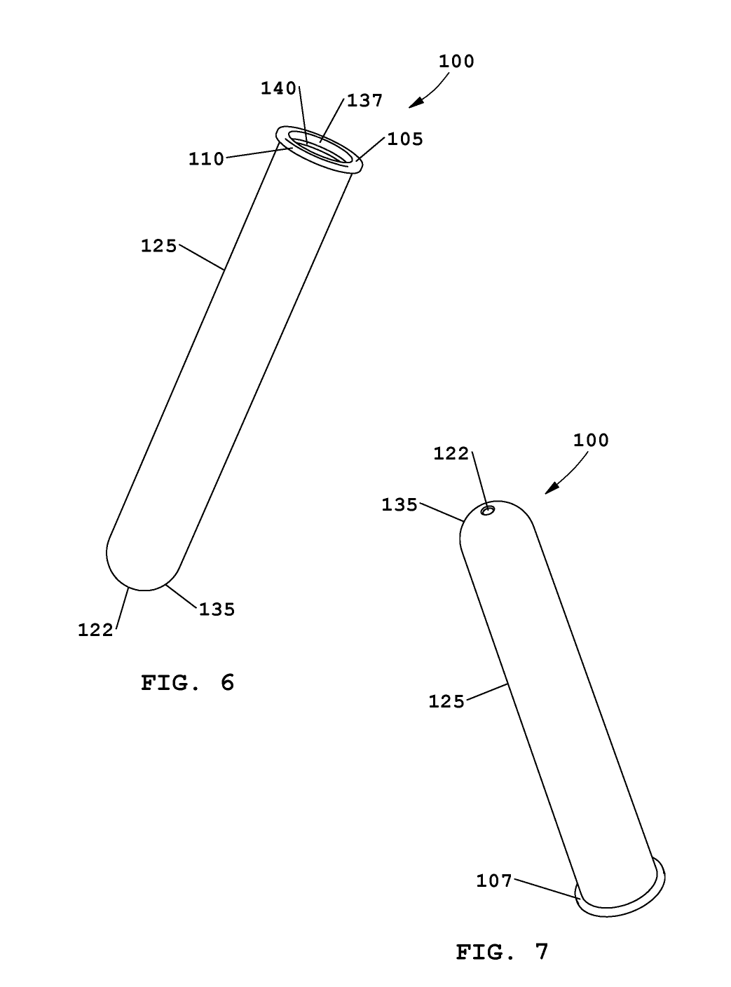

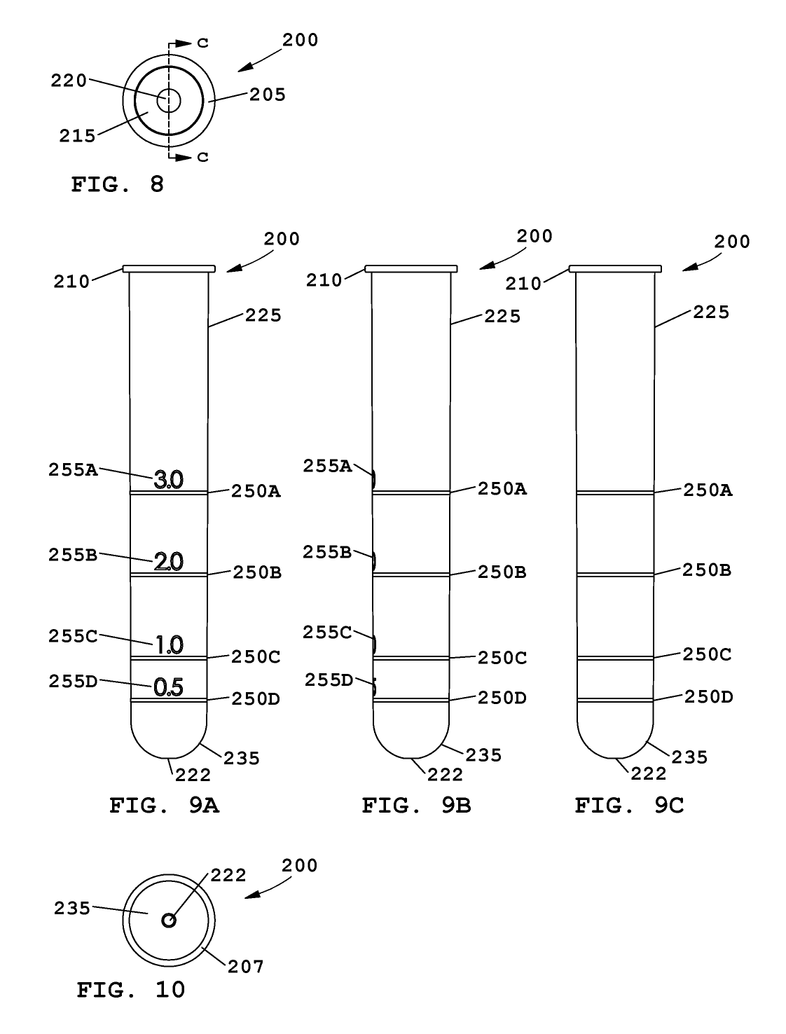

Tube element counterparts are provided in Table 1 for tube embodiment 200, illustrated in FIG. 8 to FIG. 14, which includes examples of volumetric line graduations 250A to 250D and corresponding volume designations 255A to 255D. A tube can include (i) no volumetric line graduations and no volume designations, (ii) volumetric line graduations without volume designations, or (iii) volumetric line graduations and volume designations. Any suitable number of volumetric line graduations and/or volume designations can be provided, and can be provided in any suitable form (e.g., ink, etching, embossed, different texture than the tube exterior wall, and the like).

Tube 100 or 200 can be manufactured from a polymer or polymer mixture (e.g., a polymer mixture that includes polypropylene), sometimes has a wall thickness of about 0.03 inches to about 0.06 inches (e.g., about 0.03 inches, about 0.045 inches) and sometimes weighs about 1.0 grams to about 2.3 grams (e.g., about 1.5 grams to about 2.1 grams, about 1.6 grams to about 2.0 grams, about 1.7 grams to about 1.9 grams or about 1.8 grams).

Tube element counterparts are provided in Table 1 for tube embodiments 500 and 600, illustrated in FIG. 25 to FIG. 38, which are configured to engage cap embodiment 700 shown in FIG. 39 to FIG. 44. Tube 500 or 600 can be manufactured from a polymer or polymer mixture (e.g., a polymer mixture that includes polypropylene), sometimes has a wall thickness of about 0.03 inches to about 0.06 inches (e.g., about 0.03 inches, about 0.045 inches) and sometimes weighs about 1.8 grams to about 3.3 grams (e.g., about 2.0 grams to about 2.7 grams, about 2.1 grams to about 2.6 grams, about 2.2 grams to about 2.5 grams, about 2.3 grams to about 2.4 grams, about 2.35 grams or about 2.36 grams).

### Tube and Cap Assemblies

Provided in certain embodiments are assemblies of tube and cap components described herein. In some embodiments, a cap is joined with a tube to provide a tube/cap assembly, and sometimes the cap is in sealing engagement with the tube in the assembly. A tube/cap assembly can include a fluid or not include a fluid in certain embodiments. Non-liming examples of a fluid include a laboratory sample (e.g., urine, blood, blood fraction (e.g., plasma, serum, blood cells)) before application of a laboratory procedure, a modified laboratory sample generated in the process of conducting a laboratory procedure, and a modified laboratory sample after application of a laboratory procedure.

For embodiments in which a cap is in sealing engagement with a tube, the sealing engagement sometimes is air-tight and prevents any fluid in the tube from exiting the tube. In certain embodiments a pressure differential between the external pressure and internal pressure of a sealed tube/cap assembly of greater than about 6 kilopascals (kPa) is required to disrupt the seal between the cap and the tube. The pressure differential is the internal pressure in the tube/cap assembly less the external pressure outside the tube/cap assembly. For example, an external pressure of less than 95 kPa sometimes is required to disrupt the seal between a cap and the tube, where the internal pressure in a sealed tube is about equal to one atmosphere of pressure (e.g., about 101 kPa). The pressure differential required to disrupt the seal between a cap and a tube sometimes is about 5 kPa to about 20 kPa or about 6 kPa to about 10 kPa (e.g., a pressure differential of about 5, 6, 7, 8, 9, 10, 11, 12, 13, 14 or 15 kPa), in some embodiments. Disruption of a seal between a cap and tube can be evidenced in any suitable manner, including without limitation, detecting fluid contained in a sealed tube/cap assembly that escapes the tube after applying a pressure externally to the sealed tube/cap assembly that is lower than the internal pressure of the sealed tube/cap assembly.

A tube insert region of a cap typically is configured to facilitate a seal between the cap and tube in a tube/cap assembly. A seal between a tube and a cap can be afforded in any suitable manner. A seal in some embodiments is afforded by an interference fit between a cap and a tube. In certain embodiments, annular projections of a tube are in contact with annular projections of a cap. A cap and a tube can have any suitable number of annular projections to afford a seal, and sometimes a cap and tube independently include 1, or about 2, 3, 4, 5 or 6, annular projections. A tube and a cap sometimes include the same number of annular projections. In some embodiments, one or more annular projections in a tube interfere with one or more annular projections in a cap.

In some embodiments, a tube includes a first tube annular projection and a second tube annular projection in the cap insertion region, where the first tube annular projection is proximal to the second tube annular projection. In certain embodiments, a cap includes a first cap annular projection and a second cap annular projection in the tube insert region, where the first cap annular projection is proximal to the second cap annular projection. In some embodiments, the first tube annular projection contacts the first cap annular projection, and the second tube annular projection contacts the second cap annular projection. In certain embodiments, the first cap annular projection and the second cap annular projection each include an apex and a contact region proximal to the apex, the first tube annular projection contacts the contact region of the first cap annular projection, and the second tube annular projection contacts the contact region of the second cap annular projection.

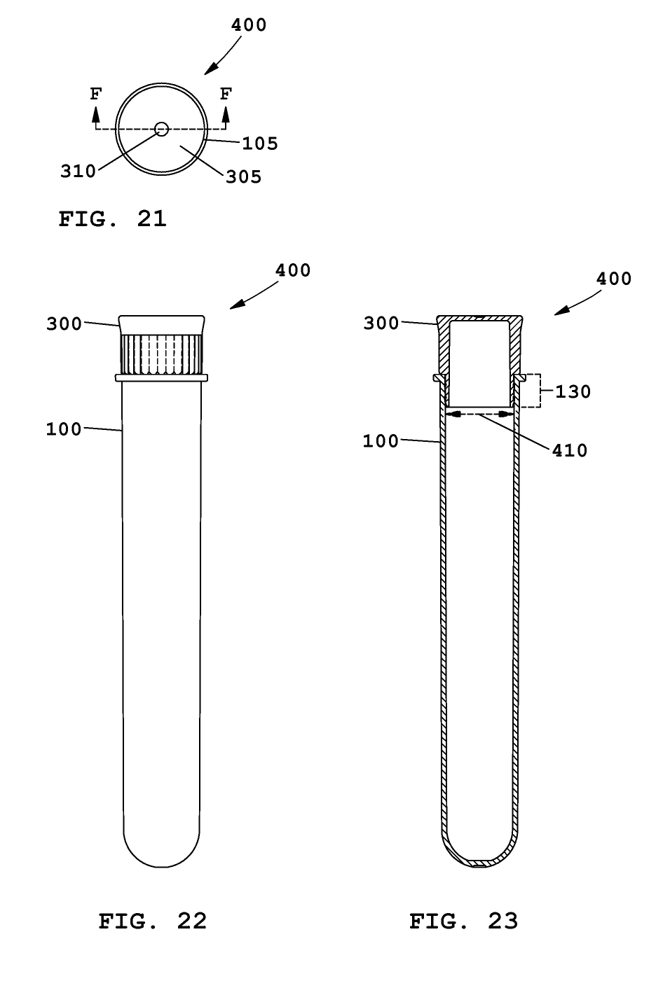

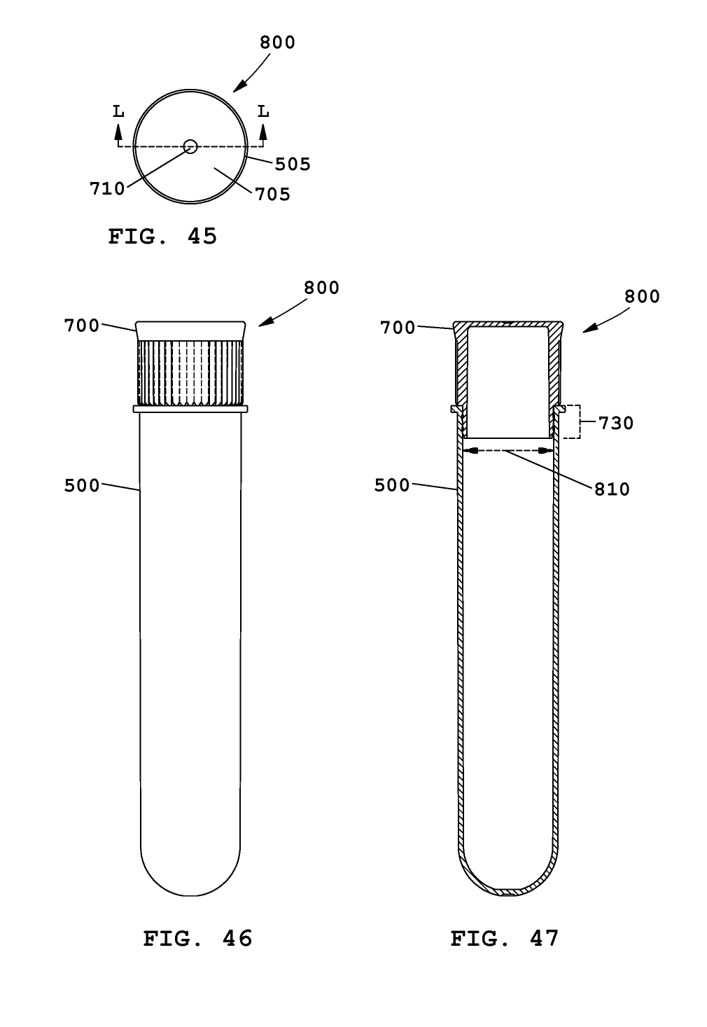

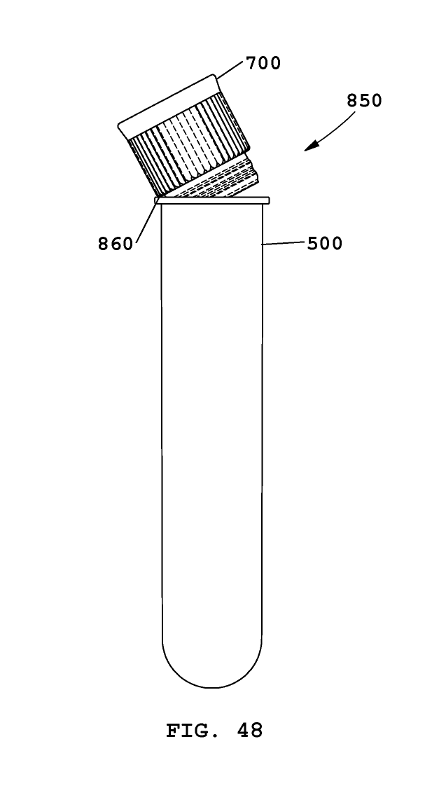

A non-limiting example of an assembly is assembly 400 formed by engagement of tube 100 with cap 300, as illustrated in FIG. 21 to FIG. 23. Assembly 400 includes tube 100 having cap insertion region 130 configured to receive the tube insert region of cap 300. Tube 100 includes interior diameter 410 shown in FIG. 23. Assembly element counterparts are provided in Table 1 for assembly 800 illustrated in FIG. 45 to FIG. 47.

In addition to facilitating a seal between a cap and a tube, a tube insert region of a cap also typically is configured for enhanced ergonomic use by an operator, as addressed above. In certain embodiments, a cap/tube assembly includes a pivot point between the cap and tube. When engaged with a tube, the tube insert region of the cap sometimes is configured to permit pivoting movement of the cap with respect to a point located on the interior rim of the tube opening. Pivoting the cap at this point on the tube can break the seal between the tube and cap and permit removal of the cap from the tube for manipulation of fluid in the tube. The cap may be pivoted at the pivot point by applying a relatively small force to the exterior surface of the cap. Without being limited by theory, the axial length of the tube insert region of a cap can facilitate this pivoting action and can thereby facilitate ergonomic displacement of a cap from/on a tube. The axial length of the tube insert region of a cap sometimes is short enough that a surface of the tube insert region of the cap does not contact a surface of the tube interior prior to, and sometimes after, the seal between the cap and the tube being disrupted.

In some embodiments, the ribs of a cap define a step adjacent to the tube insert region and the flange of the tube comprises a proximal surface. In certain embodiments, the pivot point is disposed at a point on the flange proximal surface of the tube and is disposed at a point on the step of the cap, and the tube insert region of the cap is configured to permit the cap to pivot with respect to the tube at the pivot point.

A non-limiting example of an assembly in which a cap is in a pivoted arrangement with respect to a tube is assembly 450 illustrated in FIG. 24. Cap 300 is pivoted at and around pivot point 460 with respect to tube 100, and with respect to the non-pivoted and sealed assembly 400. Assembly element counterparts are provided in Table 1 for assembly 850 illustrated in FIG. 48, in which cap 700 is shown in pivoted arrangement with respect to tube 500.

### Methods of Use

A tube can be engaged with a cap and sometimes a cap is disengaged from a tube. After a cap is disengaged from a tube, a fluid can be added to, removed from, or manipulated in, the tube. Non-limiting examples of fluids are described herein. In the process of disengaging a cap from a tube in a sealed tube/cap assembly, a force may be applied to the cap sufficient to disrupt the sealing engagement between the cap and the tube. In certain embodiments, the force pivots the cap with the respect to the tube at a pivot point (described in greater detail above), and often the force is in an amount and direction sufficient to pivot the cap with respect to the tube at the pivot point. In some embodiments, the direction of the applied force is at an angle of about 5 degrees to about 90 degrees to the axial direction of the ribs, where zero degrees is defined along the axial length of the ribs and in the direction of the distal terminus of the ribs, and where 180 degrees is defined along the axial length of the ribs and in the direction of the proximal terminus of the ribs. In certain embodiments, the force is applied (i) to one or more of the ribs of the cap, and/or (ii) to a portion of the proximal sidewall of the cap.

### Methods of Manufacture

A tube or cap may be manufactured by any suitable process. Non-limiting examples of manufacturing processes include thermoforming, vacuum forming, pressure forming, plug-assist forming, reverse-draw thermoforming, matched die forming, extrusion, casting and injection molding.

As described herein, a cap sometimes includes a polymer and sometimes is manufactured from a polymer mixture. In certain embodiments, a tube includes a polymer and sometimes is manufactured from a polymer mixture. A cap sometimes is manufactured by a method that includes: providing a mold configured to form features of a cap described herein; introducing a moldable polymer mixture to the mold; curing the polymer mixture in the mold, thereby forming the cap; and releasing the cap from the mold. A tube sometimes is manufactured by a method that includes: providing a mold configured to form features of a tube described herein; introducing a moldable polymer mixture to the mold; curing the polymer mixture in the mold, thereby forming the tube; and releasing the tube from the mold.

A tube and/or cap sometimes is manufactured from an injection molding process. Injection molding is a manufacturing process for producing objects from thermoplastic (e.g., nylon, polypropylene, polyethylene, polystyrene and the like, for example) or thermosetting plastic (e.g., epoxy and phenolics, for example) materials. A plastic material (e.g., a polymer material) of choice often is fed into a heated barrel, mixed, and forced into a mold cavity where it cools and hardens to the configuration of the mold cavity. The melted material sometimes is forced or injected into the mold cavity, through openings (e.g., a sprue), under pressure. A pressure injection method often ensures the complete filling of the mold with the melted plastic. After the mold cools, mold portions are separated, and the molded object is ejected.

A plastic with higher flow and lower viscosity sometimes is selected for use in injection molding processes. Non-limiting examples of plastics with higher flow and lower viscosity include any suitable moldable material having one or more of the following properties: a melt flow rate (230 degrees Celsius at 2.16 kg) of about 30 to about 75 grams per 10 minutes using an ASTM D 1238 test method; a tensile strength at yield of about 3900 to about 5000 pounds per square inch using an ASTM D 638 test method; a tensile elongation at yield of about 7 to about 14% using an ASTM D 638 test method; a flexural modulus at 1% sectant of about 110,000 to about 240,000 pounds per square inch using an ASTM D 790 test method; a notched Izod impact strength (23 degrees Celsius) of about 0.4 to about 4.0 foot pounds per inch using an ASTM D 256 test method; and/or a heat deflection temperature (at 0.455 MPa) of about 160 degrees to about 250 degrees Fahrenheit using an ASTM D 648 test method. Non-limiting examples of materials that can be used include polypropylene, polystyrene, polyethylene, polycarbonate, the like, and mixtures thereof. In some embodiments, additional additives can be included in the plastic or mold to impart additional properties to the final product (e.g., anti-microbial, degradable, anti-static properties). A tube and/or cap can be injection molded as a unitary construct.

A mold often is configured to retain molten plastic in a geometry that yields the desired product upon cooling of the plastic. Injection molds sometimes are made of two or more parts. Molds typically are designed so that the molded part reliably remains on the ejector side of the mold after the mold opens, after cooling. The molded part may fall freely away from the mold when ejected from ejector side of the mold. In some embodiments, an ejector sleeve pushes the molded part from the ejector side of the mold.

Provided herein is a mold for manufacturing a tube or cap by an injection mold process, which comprises a body that forms an exterior portion of the tube or cap and a member that forms an inner surface of the tube or cap. A mold sometimes comprises one or more core pin components that form interior surfaces of the tube or cap.

### Examples of Embodiments

Provided hereafter are non-limiting examples of certain embodiments of the technology.

A1. A cap configured to engage with a fluid handling tube, which cap comprises:
a proximal terminal surface;
a distal opening;
an interior void;
a tube insert region disposed proximal to the distal opening and comprising:
   two or more annular projections disposed on the tube insert region, and
   a circumference around an exterior surface of the tube insert region disposed proximal to the annular projections; and
axially oriented ribs disposed around the circumference, disposed proximal to the tube insert region, and disposed distal to the proximal terminal surface;
which tube insert region comprises an axial length and a minimum outer diameter between the annular projections, wherein a ratio of the axial length to the diameter is less than 0.62.

A2. The cap of embodiment A1, which comprises a polymer.

A3. The cap of embodiment A2, which is manufactured from a polymer.

A4. The cap of embodiment A1 or A2, wherein the polymer is chosen from polypropylene, polyethylene, high-density polyethylene, low-density polyethylene, polyethylene teraphthalate, polyvinyl chloride, polytetrafluoroethylene, polystyrene, high-density, acrylnitrile butadiene styrene, crosslinked polysiloxane, polyurethane, (meth)acrylate-based polymer, cellulose, cellulose derivative, polycarbonate, and tetrafluoroethylene polymer.

A5. The cap of embodiment A4, wherein the polymer is polypropylene.

A6. The cap of any one of embodiments A1 to A5, wherein the diameter is about 0.32 inches to about 0.45 inches.

A7. The cap of embodiment A6, wherein the diameter is about 0.387 inches.

A8. The cap of any one of embodiments A1 to A5, wherein the diameter is about 0.45 inches to about 0.58 inches.

A9. The cap of embodiment A8, wherein the diameter is about 0.516 inches.

A10. The cap of any one of embodiments A1 to A7, wherein the ratio is less than about 0.61, is less than about 0.60, is less than about 0.59, is less than about 0.58, is less than about 0.57, is less than about 0.56, is less than about 0.55, is less than about 0.54, is less than about 0.53, is less than about 0.52, is less than about 0.51, is less than about 0.50, is less than about 0.49, is less than about 0.48, is less than about 0.47, is less than about 0.46, is less than about 0.45, is less than about 0.44, is less than about 0.43, is less than about 0.42, is less than about 0.41, is less than about 0.40, is less than about 0.39, is less than about 0.38, is about 0.2 to about 0.62, is about 0.2 to about 0.61, is about 0.2 to about 0.60, is about 0.21 to about 0.59, is about 0.22 to about 0.58, is about 0.23 to about 0.57, is about 0.24 to about 0.56, is about 0.25 to about 0.55, is about 0.26 to about 0.54, is about 0.27 to about 0.53, is about 0.28 to about 0.52, is about 0.29 to about 0.51, is about 0.30 to about 0.50, is about 0.30 to about 0.55, is about 0.30 to about 0.55, is about 0.31 to about 0.55, is about 0.32 to about 0.55, is about 0.33 to about 0.55, is about 0.34 to about 0.55, or is about 0.35 to about 0.55.

A11. The cap of embodiment A10, wherein the ratio is about 0.35 to about 0.55.

A12. The cap of any one of embodiments A1 to A11, wherein the axial length of the tube insert region is about 1.5 inches to about 2.5 inches.

A13. The cap of embodiment A12, wherein the axial length of the tube insert region is about 0.17 inches to about 0.22 inches, is about 0.18 inches to about 0.21 inches, or is about 0.19 inches to about 0.20 inches.

A14. The cap of embodiment A13, wherein the axial length of the tube insert region is about 0.195 inches.

A15. The cap of any one of embodiments A1 to A14, wherein the annular projections extend about 0.001 inches to about 0.01 inches from the exterior surface of the tube insert region disposed proximal to the annular projections.

A16. The cap of embodiment A15, wherein the annular projections extend about 0.002 inches to about 0.006 inches from the exterior surface of the tube insert region disposed proximal to the annular projections.

A17. The cap of embodiment A15, wherein the annular projections extend about 0.005 inches to about 0.009 inches from the exterior surface of the tube insert region disposed proximal to the annular projections.

B1. A composition comprising a fluid handling tube and a cap of any one of embodiments A1 to A17.

B2. The composition of embodiment B1, wherein the tube comprises a polymer.

B3. The composition of embodiment B2, wherein the tube is manufactured from a polymer.

B4. The composition of embodiment B1 or B2, wherein the polymer is chosen from polypropylene, polyethylene, high-density polyethylene, low-density polyethylene, polyethylene teraphthalate, polyvinyl chloride, polytetrafluoroethylene, polystyrene, high-density, acrylnitrile butadiene styrene, crosslinked polysiloxane, polyurethane, (meth)acrylate-based polymer, cellulose, cellulose derivative, polycarbonate, and tetrafluoroethylene polymer.

B5. The composition of embodiment B4, wherein the polymer is polypropylene.

B6. The composition of any one of embodiments B1 to B5, wherein the tube comprises a proximal opening, a flange around the proximal opening, a sidewall, an interior, a cap insertion region in the interior and distal to the opening, and a bottom.

B7. The composition of embodiment B6, wherein the tube comprises tube annular projections in the cap insertion region.

B8. The composition of embodiment B7, wherein the cap insertion region comprises an inside diameter of about 0.32 inches to about 0.45 inches disposed proximal to the tube annular projections.

B9. The composition of embodiment B8, wherein the inside diameter is about 0.41 inches.

B10. The composition of embodiment B7, wherein the inside diameter is about 0.45 inches to about 0.58 inches proximal to the tube annular projections.

B11. The composition of embodiment B10, wherein the inside diameter is about 0.54 inches.

B12. The composition of any one of embodiments B1 to B11, wherein the tube comprises a rounded bottom.

B13. The composition of any one of embodiments B1 to B12, wherein the cap is in sealing engagement with the tube.

B14. The composition of embodiment B13, wherein:
a pressure differential of greater than about 6 kilopascals (kPa) is required to disrupt the seal between the cap and the tube, and
the pressure differential is internal pressure within a sealed tube/cap composition less external pressure outside the sealed tube/cap composition.

B15. The composition of embodiment B13 or B14, wherein the tube annular projections of the tube are in contact with the annular projections of the cap.

B16. The composition of embodiment B15, wherein:
the tube comprises a first tube annular projection and a second tube annular projection in the cap insertion region,
the first tube annular projection is proximal to the second tube annular projection,
the cap comprises a first cap annular projection and a second cap annular projection in the tube insert region,
the first cap annular projection is proximal to the second cap annular projection,
the first tube annular projection contacts the first cap annular projection, and
the second tube annular projection contacts the second cap annular projection.

B17. The composition of embodiment B16, wherein:
the first cap annular projection and the second cap annular projection each comprise an apex and a contact region proximal to the apex,
the first tube annular projection contacts the contact region of the first cap annular projection, and
the second tube annular projection contacts the contact region of the second cap annular projection.

B18. The composition of any one of embodiments B1 to B17, wherein the ribs of the cap define a step adjacent to the tube insert region and the flange of the tube comprises a proximal surface.

B19. The composition of any one of embodiments B1 to B18, comprising a pivot point between the cap and tube.

B20. The composition of embodiment B19, wherein:
the pivot point is disposed at a point on the flange proximal surface of the tube and is disposed at a point on the step of the cap, and
the tube insert region of the cap is configured to permit the cap to pivot with respect to the tube at the pivot point.

C1. A method, comprising:
obtaining a composition of any one of embodiments B1 to B12, and
engaging the cap with the tube.

C2. A method, comprising
obtaining a composition of any one of embodiments B13 to B20, and
applying a force to the cap sufficient to disrupt the sealing engagement between the cap and the tube.

C3. The method of embodiment C2, wherein the force pivots the cap with the respect to the tube at the pivot point.

C4. The method of embodiment C3, wherein the force is in an amount and direction sufficient to pivot the cap with respect to the tube at the pivot point.

C5. The method of embodiment C4, wherein the direction is at an angle of about 5 degrees to about 90 degrees to the axial direction of the ribs.

C6. The method any one of embodiments C2 to C5, wherein the cap comprises a proximal sidewall disposed distal to the proximal terminal surface and proximal to the ribs.

C7. The method of embodiment C6, wherein the force is applied (i) to one or more of the ribs of the cap, and/or (ii) to a portion of the proximal sidewall of the cap.

D1. A mold configured to manufacture a cap of any one of embodiments A1 to A17.

D2. A mold configured to manufacture a tube of any one of embodiments B1 to B20.

D3. A method for manufacturing a cap configured to engage with a fluid handling tube, comprising:
providing a mold configured to form features of a cap of any one of embodiments A1 to A17;
introducing a moldable polymer to the mold;
curing the polymer in the mold, thereby forming the cap; and
releasing the cap from the mold.
   D4. A method for manufacturing a fluid handling tube configured to engage with a cap, comprising:
providing a mold configured to form features of a tube of any one of embodiments B1 to B20;
introducing a moldable polymer to the mold;
curing the polymer in the mold, thereby forming the tube; and
releasing the tube from the mold.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Their citation is not an indication of a search for relevant disclosures. All statements regarding the date(s) or contents of the documents is based on available information and is not an admission as to their accuracy or correctness.

Modifications may be made to the foregoing without departing from the basic aspects of the technology. Although the technology has been described in substantial detail with reference to one or more specific embodiments, those of ordinary skill in the art will recognize that changes may be made to the embodiments specifically disclosed in this application, yet these modifications and improvements are within the scope and spirit of the technology.

The technology illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” can refer to one of or a plurality of the elements it modifies (e.g., “a reagent” can mean one or more reagents) unless it is contextually clear either one of the elements or more than one of the elements is described. The term “about” as used herein refers to a value within 10% of the underlying parameter (i.e., plus or minus 10%), and use of the term “about” at the beginning of a string of values modifies each of the values (i.e., “about 1, 2 and 3” refers to about 1, about 2 and about 3). For example, a weight of “about 100 grams” can include weights between 90 grams and 110 grams. Further, when a listing of values is described herein (e.g., about 50%, 60%, 70%, 80%, 85% or 86%) the listing includes all intermediate and fractional values thereof (e.g., 54%, 85.4%). Thus, it should be understood that although the present technology has been specifically disclosed by representative embodiments and optional features, modification and variation of the concepts herein disclosed may be resorted to by those skilled in the art, and such modifications and variations are considered within the scope of this technology.

Certain embodiments of the technology are set forth in the claim(s) that follow(s).

1-49. (canceled)

50. A composition comprising a fluid handling tube and a cap configured to engage with the tube,
which cap comprises:
a proximal terminal surface;
a distal opening;
an interior void;
a tube insert region disposed proximal to the distal opening and comprising:
two or more annular projections disposed on the tube insert region, and
a circumference around an exterior surface of the tube insert region disposed proximal to the annular projections; and axially oriented ribs disposed around the circumference, disposed proximal to the tube insert region, and disposed distal to the proximal terminal surface;
which tube insert region comprises an axial length and a minimum outer diameter between the annular projections, wherein a ratio of the axial length to the diameter is less than 0.62;
which tube comprises:
a proximal opening,
a flange around the proximal opening,
a sidewall,
an interior,
a cap insertion region in the interior and distal to the opening;
a bottom, and
two or more annular projections disposed in the cap insertion region.

51. The composition of claim 50, wherein the cap and the tube comprise a polymer.

52. The composition of claim 51, wherein the polymer is polypropylene.

53. The composition of claim 50, wherein the diameter is about 0.32 inches to about 0.45 inches.

54. The composition of claim 50, wherein the diameter is about 0.45 inches to about 0.58 inches.

55. The composition of claim 50, wherein the ratio is about 0.35 to about 0.55.

56. The composition of claim 50, wherein the axial length of the tube insert region is about 1.5 inches to about 2.5 inches.

57. The composition of claim 50, wherein the annular projections extend about 0.001 inches to about 0.01 inches from the exterior surface of the tube insert region disposed proximal to the annular projections.

58. The composition of claim 50, wherein the cap insertion region comprises an inside diameter of about 0.32 inches to about 0.45 inches disposed proximal to the tube annular projections.

59. The composition of claim 50, wherein the cap insertion region comprises an inside diameter of about 0.45 inches to about 0.58 inches disposed proximal to the tube annular projections.

60. The composition of claim 50, wherein the cap is in sealing engagement with the tube.

61. The composition of claim 60, wherein:
a pressure differential of greater than about 6 kilopascals (kPa) is required to disrupt the seal between the cap and the tube, and
the pressure differential is internal pressure within a sealed tube/cap composition less external pressure outside the sealed tube/cap composition.

62. The composition of claim 60, wherein the tube annular projections of the tube are in contact with the annular projections of the cap.

63. The composition of claim 62, wherein:
the tube comprises a first tube annular projection and a second tube annular projection in the cap insertion region,
the first tube annular projection is proximal to the second tube annular projection,
the cap comprises a first cap annular projection and a second cap annular projection in the tube insert region,
the first cap annular projection is proximal to the second cap annular projection,
the first tube annular projection contacts the first cap annular projection, and
the second tube annular projection contacts the second cap annular projection.

64. The composition of claim 63, wherein:
the first cap annular projection and the second cap annular projection each comprise an apex and a contact region proximal to the apex,
the first tube annular projection contacts the contact region of the first cap annular projection, and
the second tube annular projection contacts the contact region of the second cap annular projection.

65. The composition of claim 1, wherein the ribs of the cap define a step adjacent to the tube insert region and the flange of the tube comprises a proximal surface.

66. The composition of claim 65, comprising a pivot point between the cap and tube.

67. The composition of claim 66, wherein:
the pivot point is disposed at a point on the flange proximal surface of the tube and is disposed at a point on the step of the cap, and
the tube insert region of the cap is configured to permit the cap to pivot with respect to the tube at the pivot point.

68. A method, comprising
obtaining a composition of claim 60; and
applying a force to the cap sufficient to disrupt the sealing engagement between the cap and the tube,
wherein the force pivots the cap with the respect to the tube at the pivot point.

69. The method of claim 68, wherein the force is in an amount and direction sufficient to pivot the cap with respect to the tube at the pivot point.
